(19) United States
(12) Patent Application Publication
(10) Pub. No.: US 2009/0046747 A1
(43) Pub. Date: Feb. 19, 2009

(54) External Cavity for Generating a Stimulus Signal and Filtering a Response Signal Received From a Dut

(75) Inventors: Ruediger Maestle, Waldbronn (DE); Doug Baney, Santa Clara, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/092,898

(22) PCT Filed: Nov. 15, 2005
(86) PCT No.: PCT/EP05/55998

§ 371 Date: May 7, 2008

(51) Int. Cl. H01S 3/10; G01N 21/00

(52) U.S. Cl. 372/20; 356/73

(57) ABSTRACT

Deriving an optical property of a device under test includes generating a cavity light beam along a first optical path in external cavity, selecting a wavelength of the cavity light beam of light by means of a filter arrangement within the external cavity, providing an optical stimulus signal to a device under test by splitting at least a fraction of the cavity light beam, providing an optical response signal from the DUT or a signal derived there form back to the external cavity, so that said signal is passed over a second optical path passing the filter arrangement spatially different to the first optical path in order to generate a filtered optical response signal, and providing said filtered optical response signal to a detector unit.

This application is the National Stage of International Application No. PCT/EP2005/055998, filed on 15 Nov. 2005 which designated the United States of America, and which international application was published as Publication No. WO 2007/057050.

### BACKGROUND ART

The present invention relates providing optical filtering in DUT measurement applications.

In recent years, the requirements with respect to optical components such as those employed in optical networks have continuously been increased in order to facilitate larger transmission efficiencies as well as a reduction of costs per bit. Bit rates beyond the 40 Gbit limit and tight channel spacings below 25 GHz had to be achieved. As, for example, also longer distances in those networks have to be accomplished and the number of optical amplifiers in networks steadily decreases for cost reasons, it becomes clear from the foregoing, that besides the conventional loss measurements, the effect of dispersion further has to be accounted for. This lead to the development of so-called all-parameter-tests of optical components as the devices under test.

Therein, for example an optical stimulus signal is generated and input to the optical device under test. The output signal thereof may then be forwarded to a power meter for measuring the intensity, or a similar quantity, as a function of wavelength. The wavelength dependence of the output or response signal may be obtained by tuning the wavelength of the stimulus signal with time using a tunable light source. The tunable light source thereby delivers a stimulus signal, which has most of its intensity contribution near its currently tuned wavelength. The power meter, however, may measure intensity contributions of the output signal having any wavelength, i.e., it outputs an integrated intensity value. This output intensity is associated with the input wavelength, and by means of further processing, is transformed into a set of optical parameters, which may, e.g., be compared with a pre-defined specification of the corresponding optical parameter.

It is known to restrict the output or response signal from the optical device under test to a specific passband in wavelength for the reason, that the stimulus signal has a limited ratio of the intensity contributed within a peak near the tuned wavelength to that intensity contributed by noise in other sidebands. This limited ratio may lead, e.g., in case of measuring gas cells for the purpose of calibration, to absorption profiles (versus wavelength), wherein the absorption lines cannot be measured to their full depth as the sideband noise still contributes a disadvantageous signal level. The passband restriction, or filtering, of the response signal from the DUT thus serves to increase this ratio.

### SUMMARY OF THE INVENTION

It is an object of the invention to provide an improved filtering. The object is solved by the independent claims. Further embodiments are shown by the dependent claims.

According to embodiments of the invention, an external cavity provides a first optical path or optical axis passing or crossing a tunable filter arrangement, the tunable filter arrangement (or cavity wavelength selective filter) selecting a wavelength of a cavity light beam resonating in the external cavity. The external cavity comprises a first port for providing at least a fraction of the resonating cavity light beam as an optical stimulus signal to a DUT, a second port for receiving an optical response signal from the DUT or an optical response signal derived from said optical response signal, and a third port for outputting a filtered response signal, wherein the second port and the third port are forming the end points of a second optical path or optical axis. The second optical path again crosses the tunable filter arrangement, but spatially different to the resonating cavity light beam, so that the corresponding light beams are not influencing each other. Therewith, the response signal from the DUT is automatically filtered synchronously to the wavelength of the stimulus signal. This allows for exactly wavelength selecting the spectral part around the wavelength of the stimulus signal. This is especially advantageous when sweeping the wavelength of the stimulus signal, as both the wavelength selection and the filtering of the response signal are always synchronous without any time delay. The external cavity may include optically non-reciprocal functions such as optical isolation or optical circulation, in integrated optics, optical fiber, or free-space bulk optics as needed to suppress unwanted optical reflections or otherwise direct light in a non-reciprocal fashion. Optical isolation and optical circulation are commonly achieved through the application of the optical Faraday effect as is well-known in the art, though other means may be considered as well.

According to further embodiments of the present invention, an apparatus for deriving an optical property of a device under test by means of a loss and/or group delay parameter measurement is provided. The apparatus comprises a tunable light source having a light source, which may be a laser, and an external cavity. The cavity refers to an arrangement, which is designed to form resonance modes with respect to a beam of light generated by the light source and lead into the cavity arrangement. In particular, depending on the specific settings of the arrangement, resonance modes form with respect to one wavelength while intensity contributions due to other wavelengths are lost. As a result the tunable light source may emit a beam of light, or stimulus signal, which is characterized by a spectrum having a peak at a desired wavelength, wherein the peak has a particularly small width.

Further, the arrangement being designed to form an external cavity is tunable with regard to the wavelength corresponding to the respective resonance modes. For example, an optical path is defined in the arrangement by two cavity end reflectors, at least of them being semitransparent for coupling in the beam of light originating from the light source. In one embodiment, the arrangement is compatible with a so-called Littmann-type cavity. According to such an embodiment, a grating is included in the optical path, which performs diffraction of the light beam. From multiple resonance modes, one specific mode is selected by means of the grating, wherein the angles of the optical path, or the cavity end reflectors, with respect to the grating play an important role. What is important is, that the settings of the arrangement, which provides the cavity, may be changed (optical path length, grating angles in the embodiment detailed above) in order to affect the resonance modes and thus the wavelength of the intensity peak. Accordingly, the tunable light source allows sweeping the wavelength of the stimulus signal with time over a considerable wavelength range.

The stimulus signal is input to the optical device under test (DUT). The connection may be established by fiber or bulk optics and the invention is not limited to the particular manner in which the optical connections between the constituent parts of the apparatus are facilitated. The DUT will presumably lead to a loss and/or dispersion (group delay) with regard to the wavelength and/or polarization mode of the stimulus signal.

The thus affected output or response signal is then, according to an embodiment of the invention, subjected to a filtering process. As the wavelength of the stimulus signal sweeps over a wavelength range, a filter characteristic applied to the response signal provides a bandpass-like function, which co-moves with intensity peak of the stimulus signal with regard to the swept over XXX centre wavelength. The filter characteristic is derived by providing a connection between the monochromator and the tunable light source. In a more specific embodiment, a further light path is provided to the cavity arrangement, which leads the response signal originating from the DUT through the arrangement. Therein, the filter characteristic of the arrangement is used to affect the response signal.

According to one embodiment, the response signal is input into the arrangement at a position offset from that of the beam of light generated by the light source, e.g., the laser. As a result, the “response” signal of the DUT, which is input into the arrangement, is offset from the optical path. Consequently, the formation of resonance modes with regard to the response signal is suppressed. Rather, the response signal enters traverses and leaves the arrangement just once.

According to an embodiment, the output location of the filtered response signal within the arrangement is different from the input location. According to still a further embodiment, there is neither an end reflector supplied at the input nor at the output locations with respect to the response signal.

The filter characteristic applied to the response signal—after it has left the arrangement and returned to the monochromator—is accordingly considerably broader in width than the peak of the stimulus signal. However, the peak wavelength is covered by the filter characteristic and, advantageously, sweeps together with the change of the settings of the cavity arrangement (optical path length, grating angle, etc). Thus, the monochromator applies the filter characteristic synchronized with the tunable light source.

In other words, according to this embodiment, the monochromator and the tunable light source both rely on the same arrangement, wherein the explicit beam paths utilized within the arrangement are different. In the first case, a filter characteristic is applied to a beam of light (herein the response signal after passing the DUT) that performs one cycle through the arrangement on a path offset from the optical axis. In the second case, a further “filter characteristic” (i.e., the resonance formation) is applied to the beam of light (herein the stimulus signal prior to the DUT) by providing a multiple cycle resonant optical path due to the presence of, e.g., two end reflectors which provide the cavity.

According to a further embodiment, the at least one response signal is split into at least two separate signals (i.e., by polarization beam splitting) which are input into the arrangement at two or more different positions offset from that of the beam of light generated by the light source, e.g., the laser and offset from each other.

It is noted that the invention is not limited to the particular arrangement of components, which form a cavity. For example, a Littman-type cavity may be embodied as well as ring resonators or even Fabri-Perot cavities, etc. Nevertheless, a Liffman cavity having an additional off-axis beam path represents a preferred embodiment.

In this special case preferably the different beams hit the grating at the same spot but with slightly different angles of incidence.

In a further embodiment, a detector unit is arranged to be connected with said monochromator for measuring the power of the filtered optical response signal or a signal derived from the filtered response signal. The detector unit may be a power meter. The power meter measures an intensity of the filtered response signal, which is integrated over wavelength. However, detector units being capable of measuring the intensity in wavelength dependent channels for the purpose of obtaining a spectrum of the response signal are not ruled out.

Still further, a data processing unit may be connected to the detector unit for deriving the optical property of the device under test from the measured power. In an insertion loss and/or group delay (dispersion) measurement, the optical properties derived may be optical parameters such as spectral loss, polarization dependent loss (PDL), differential group delay or polarization mode dispersion (PMD), relative group delay or chromatic dispersion (CD). If all of these parameters are determined, the test is called an all-parameter-test.

According to an alternative embodiment, the apparatus may be embodied as a spectrum analysator. In this case, the DUT is an active component and outputs a signal. As in the previous embodiments this output signal is subjected to a filtering process using an arrangement of a tunable light source, which provides an external cavity for the latter. However, in contrast to the previous embodiments, the signal generated by the tunable light source is not input to the optical DUT but superimposed with the filtered response signal. Especially beam splitting and the possibility of inputting multiple signals into the filter may be advantageously in this embodiment, too.

Nevertheless, the underlying principles of the embodiments are the same: a filter characteristic is applied to a signal output by an optical DUT, which is based on the same settings of a cavity arrangement as those, with which a stimulus or test signal is generated. The broader passband of the filter characteristic co-moves, or is synchronized in wavelength, with the intensity peak of the tuned signal.

In a further aspect, not shown in the figures, the arrangement for providing an external cavity further comprises one or more additional ports spatially offset from said first port and the optical axis of the arrangement. This or these ports are designed for a repeated input of an optical signal, which refers to at least a portion of the stimulus, or first optical signal itself. In particular, it is the stimulus, or first optical signal which has previously been output from the first port being associated with the optical axis. It is thus re-input as a third optical signal into the arrangement for deriving optical properties, particularly insertion loss, of the filter arrangement. An output port located off-axis (optically) serves to retrieve a filtered stimulus signal. The filtered stimulus signal can then be forwarded directly to a detector.

Using such an embodiment, it becomes possible to determine the transmission characteristics of the filter arrangement. The insertion loss may be determined and advantageously considered, when the filtered DUT-response signal is analyzed during further processing, in order to derive the optical properties. The filtered DUT-response signal must have undergone similar insertion loss as it has also cavity filter arrangement prior to being detected by a detector

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a first embodiment of the apparatus according to the present invention;

FIG. 2 shows in a second embodiment a more detailed view of the tunable light source according to FIG. 1;

FIG. 3A-FIG. 3D show in simplified sketches further embodiments of the apparatus according to the invention;

FIG. 4 shows a side view of an embodiment of the arrangement for providing an external cavity to the light source, which includes additional beam paths for applying a filter characteristic to the out signal of the DUT;

FIG. 5 shows an example filter characteristic applied to the output signal of a DUT due to a cavity- and filter-arrangement such as that shown in FIG. 4;

FIG. 6 shows an illustration of the effects achieved by embodiments according to the invention with regard to active components;

FIG. 7 shows an illustration of the effects achieved by embodiments according to the invention with regard to passive components;

FIG. 8 shows a top view of a further embodiment of the arrangement for providing an external cavity to the light source, wherein dual lenses and a retro are employed;

FIG. 9 shows a top view of a still further embodiment of the arrangement for providing an external cavity to the light source, wherein dual lenses are employed and the optical paths of the cavity and the portion for applying the filter characteristic are separated with respect to the lenses;

FIG. 10 shows a top view of a still further embodiment of the arrangement for providing an external cavity to the light source, wherein triple lenses are employed.

### DETAILED DESCRIPTION OF EMBODIMENTS OF THE INVENTION

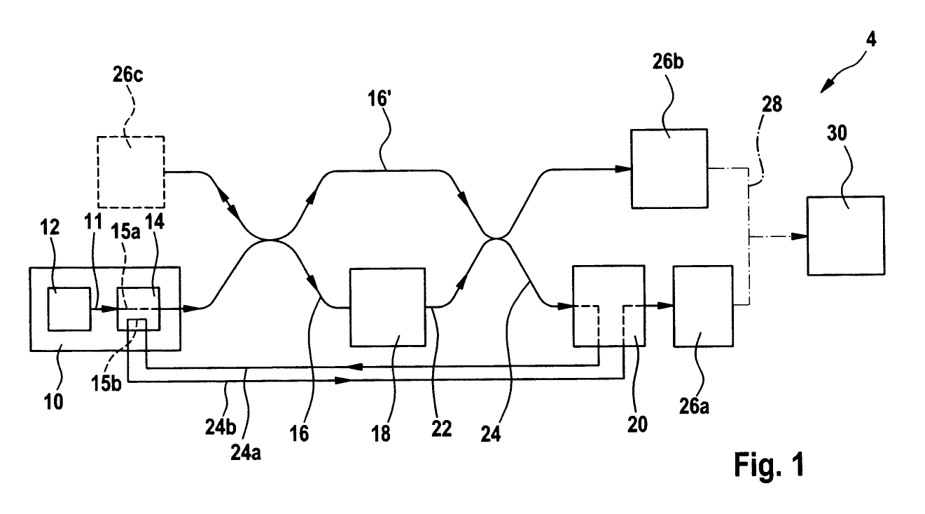

FIG. 1 shows a first embodiment of an apparatus 4 for deriving an optical property of a DUT 18 according to the invention. The setup of this apparatus refers to an all-parameter-test for deriving parameters like spectral loss, chromatic dispersion, polarization mode dispersion (PMD) or polarization dependent loss (PDL). The definition of and explicit methods to derive these parameters from measurements are well known in the art.

A beam 11 of light is generated by a light source 12, which is part of a tunable light source 10 of the apparatus 4. The light source may be a laser, for example a semiconductor laser. The beam 11 is lead into an arrangement 14 for providing an external cavity to the light source 12, which may be a Littman-type cavity as will be explained below. The cavity is defined by an optical axis 15a, along which resonance modes form. The resonance modes depend on the optical path length and in case of a Littman-type cavity, on the angle of a diffraction grating 56 included within the optical path 15 a. The diffraction grating 56 serves to select specific modes and to exclude undesired modes. The wavelength of the signal thus generated is tuned by changing at least one of the angles between cavity end reflectors 48, 50 and the diffraction grating 56.

The corresponding signal is output from the arrangement 14 of the tunable laser source 10 and forwarded to the DUT 18 as a stimulus signal 16 therefore. The signal is altered by DUT 18 according to its optical properties resulting in an output or response signal 22. Next, the response signal 22 is subjected to filtering by means of a monochromator 20. The monochromator effects a filtering based on the arrangement 14. It thus has, e.g., a fiber optic connection to the arrangement 14 in order to XXX reefed the response signal into the cavity (shown as signal 24a), however, with an path 15b offset from the optical axis 15a formed therein.

The response signal 22, 24a is subjected to a filtering process in the arrangement 14. Being filtered, it is output from the arrangement and the tunable source 10 and redirected to the monochromator 20. Note that the monochromator herein merely serves as a redirecting station with respect to the response signal and that the filtering is done by means of the arrangement 14 of the tunable light source. Thus, in a sense, the arrangement 14 simultaneously functions as an external cavity and a monochromator.

The thus filtered response signal 24 is then forwarded to a detector unit 26a, which in this embodiment is a power meter 26a. Dispersion and delay characteristics are advantageously observed by superimposing the response signal 24 with the undisturbed stimulus signal 16′, but can alternatively be determined from a modulated signal 16. Further power meters 26b, 26c may optionally be utilized to investigate other wavelength bands or the reflection of signals from the DUT 18. A processing unit 30 assembles measured data from the power meters in order to calculate and derive the optical properties of the DUT 18. Known methods such as calculating the optical parameters via the Mueller or Jones matrix, or by scrambling polarization modes and searching for maximum or minimum values may be employed.

Furthermore, with at least one additional beam path in the optical arrangement 14 the filter can also be used to filter the signals going to power meters 26b or 26c, or to allow filtering of additional signals derived from additional beam splitting, i.e., polarization beam splitting.

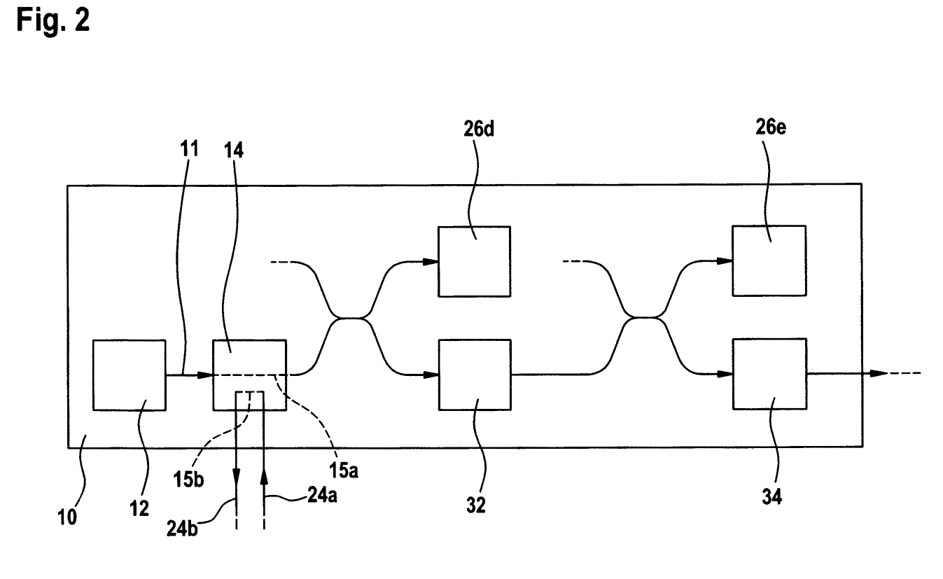

FIG. 2 shows the tunable light source unit in larger detail together with some signal conditioning elements. Therein, a polarization controller 32 is inserted within the optical path. Further power meters 26d, 26e serve to measure reference (i.e. wavelength, power and/or polarization reference signals) signals for calibration purposes. At the output 34, the stimulus signal 16 is obtained.

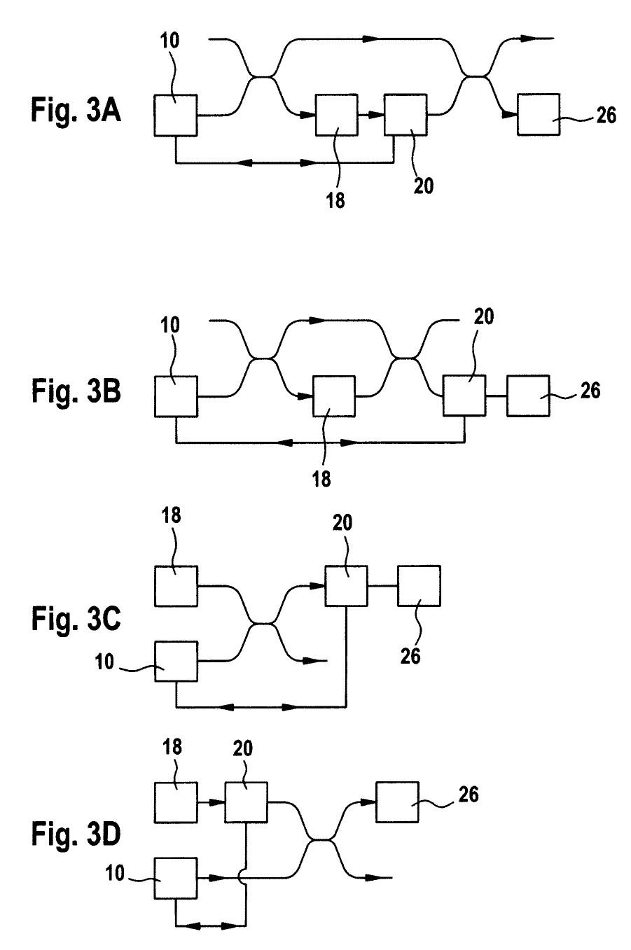

In FIG. 3A-FIG. 3D, several alternatives to the first embodiment are illustrated in a simplified manner. FIG. 3B simply repeats the first embodiment, while FIG. 3A shows a similar embodiment, wherein the monochromator is rearranged directly behind the power meter 26a within the optical signal flow path. The response signal 22 is superimposed with the stimulus signal 16 and then filtered by the monochromator, i.e., by means the arrangement 14, or is directly filtered according to the embodiments shown in FIG. 3A, and FIG. 3B.

FIG. 3C and FIG. 3D show alternatives with respect to a spectrum analyzing apparatus. The device under test 18 is an active component which on itself generates a signal that is subjected to a filtering due to the monochromator 20. The filtered signal is then superimposed with the signal output from the tunable laser source 10 in order to obtain a spectrum (FIG. 3D). Alternatively, the superimposed signal may be filtered (FIG. 3C).

The filter 20 with more than one port can be applied to filter more than one of the two recombined signals shown in FIG. 3B or FIG. 3C, or for example can be used in conjunction with polarization splitting to allow filtering of more than one signal.

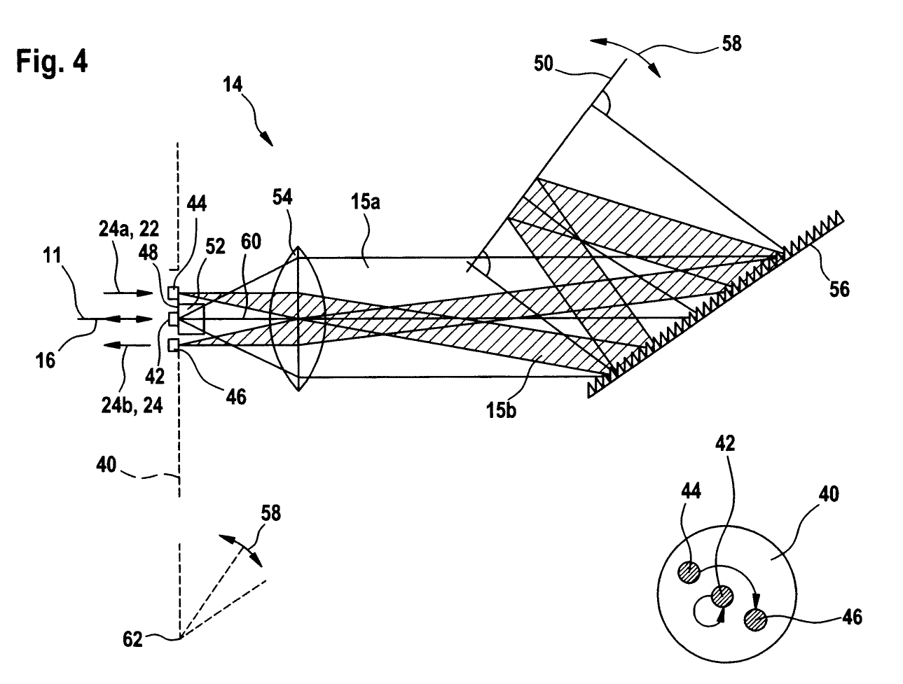

FIG. 4 shows a more detailed side view of an arrangement 14, which provides for an external cavity to the tunable laser source 10. The main parts of the arrangement are: a first cavity end reflector 48, a gain element 52, a diffraction grating 56 and a second cavity end reflector 50. A lens 54 serves to focus the beam towards the gain element 52. The beam 11 of light generated by the light source 12 is inserted into the arrangement 14 at a port 42, which coincides in location with the gain element 52. The first cavity end mirror 48 is formed by a semitransparent surface of the gain element 52, which is directed opposite to the grating 56, and resides in a focal plane 40 of the lens 54. The cavity end reflectors may be mirrors or retros, particularly with respect to the second cavity end reflector 50.

Resonance modes form in dependence of the length of the optical path 15a along the optical axis 60 of the system. The length may be changed by a movement 58 of the second cavity end reflector 50 in order to tune the wavelength. In a Littman type configuration of reflectors and gratings, the focal plane 40, which corresponds to that of the first cavity end reflector 48, the grating plane and the plane of the second cavity end reflector intersect in a pivot point 62. Under such circumstances, the resonance mode selected by the grating out of the multiply possible resonance modes is independent from the actual optical path length. It is noted that the diffraction grating thus serves to form a filter with respect to the resonance spectrum within the cavity.

Two additional ports 44, 46 are implemented within the focal plane. Port 44 is arranged to insert the response signal 22, 24a from the DUT 18 (see FIG. 1) into the cavity arrangement. Port 44 is offset from the port 42 for the stimulus signal 16, or the beam 11 generated by the light source 12, respectively. The distance between both ports is arranged to impede crosstalk of the different signals. Port 44 has at least one of the following characteristics being different from port 42: (a) it has no gain element, (b) it does not comprise a reflector, and (c) it is offset from the optical axis 60. Accordingly, the beam path 15a, which the inserted signal 22, 24a takes through the arrangement 14, does not provide the formation of resonance modes.

The same features are valid for the output port 46, where the signal is output from the arrangement 14. As a result, the beam 15b has just one cycle through the arrangement 14. Consequently, the filter characteristic, that is applied to the response signal 22, 24a due to the grating 56, is much broader than the intensity peak formed by means of the cavity (beams moving along optical axis 60) with regard to the stimulus signal 16.

In the lower left corner of FIG. 4, a front view of the positions of ports 42 (generated beam 11 (in) or stimulus signal 16 (out), herein also called local oscillator), 44 (response signal in) and 46 (response signal out) is demonstrated. Note that the local oscillator is imaged into itself in terms of port positions, while ports 44 and 46 are nearly point symmetric about the local oscillator port 42. In case, a retro is used instead of a mirror as second cavity end reflector 50, in- and output ports 44 and 46 are axial symmetric about the local oscillator port 42.

Additional ports can be included, when their position is axial symmetric (about the dispersive axis of the grating) to the ports 44 and 46.

A beam splitter or mirror (not shown) may be inserted into the beam path between the lens 54 and the grating 56 or between the focal plane 40 and the lens 54, whereby at the cost of additional loss, the local oscillator port 42 and the filtering ports can have an arbitrary large spatial separation, in order to get better access for all ports during assembly of the arrangement 14.

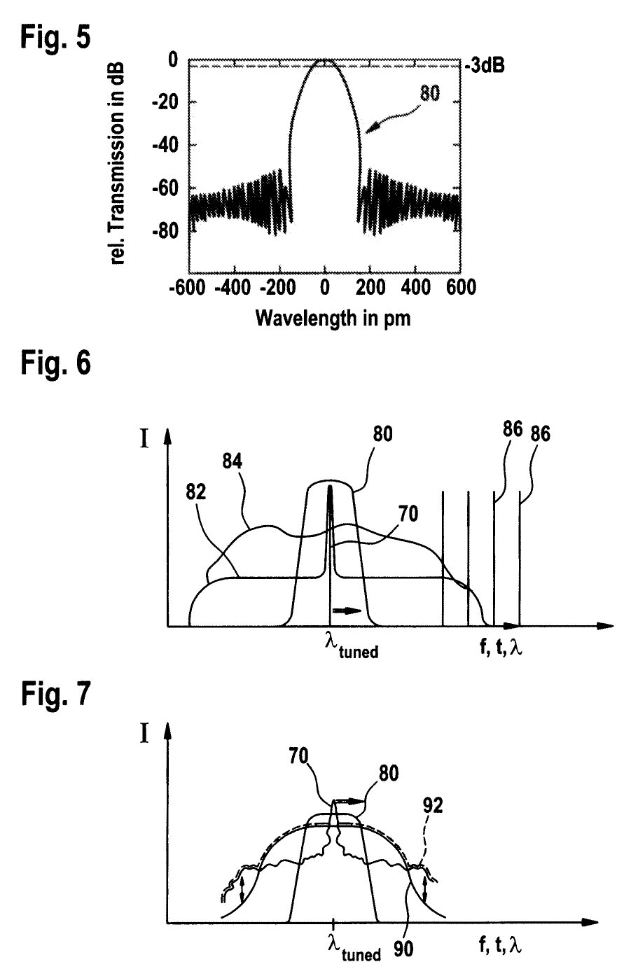

FIG. 5 shows in a diagram the actual form of the filter characteristic 80 applied to the response signal 22, 24a by means of the arrangement 14 as shown in FIG. 4. Therein, the relative transmission (in dB) is plotted versus the center wavelength of the tuned signal. The dynamic range amounts to 70 dB (at 200 μm) and the resolution band width at 3 dB amounts to 75 μm. This width has to be compared with that of the intensity peak of the finally emitted stimulus signal 16, which amounts to several 100 kHz.

FIG. 6 illustrates the effect of an embodiment being applied to measuring active optical components. The intensity is plotted versus frequency or wavelength, or time (it is noted that the tunable light source sweeps over wavelength with time) in the diagram shown. The intensity peak 70 is due to the stimulus signal 16. The response of the DUT 18 is reflected by curve 82, when there is load on the device 18, e.g., an optical amplifier. The case of no load is reflected by curve 84. As can be seen from FIG. 1, the detector unit 26a, i.e., a power meter in this embodiment obtains signals reflected by curves 82 or 84, if no filtering were applied. What the power meter actually measures is the integrated area below the curves. However, it becomes clear from FIG. 5 that the amplification quality reflected by the central peak of curve 82 contributes only a small portion to the integrated area. Relating then the load-curve 82 to the no-load-curve 84 yields a marginal difference at a large overall signal level.

Application of the filter characteristic 80 shown in FIG. 6 clearly restricts the considered wavelength range to the region of interest and thus increases the signal level with respect to background noise.

FIG. 7 shows a similar diagram for the case of passive components. Herein, curve 70 is illustrated with sideband noise, which may be due to source spontaneous emission SSE, which inevitably occurs in lasers. Curve 90 reflects the true wavelength dependent response of a passive component. The dashed curve 92 then illustrates what the power meter actually measures: as indicated by the arrows, the sidebands of the laser signal (stimulus signal 16) yield considerable contributions to the integrated signal level, which decreases the depth (measured in dB), e.g. in the case of gas cells, with which measurements can be performed.

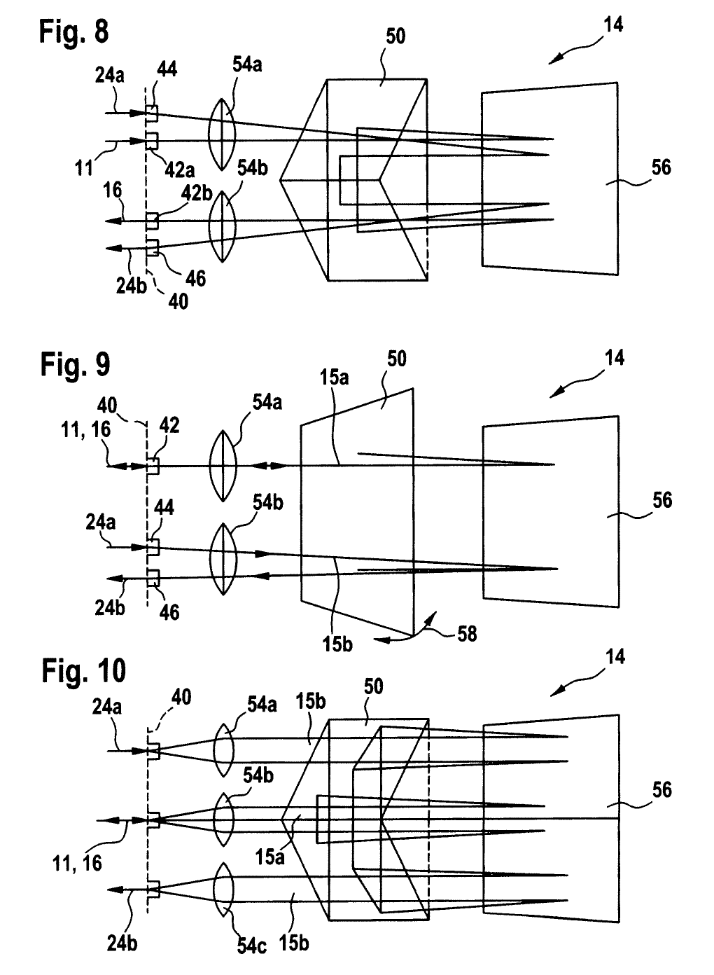

In FIG. 4, a single lens arrangement 14 has been illustrated. FIGS. 8-10 show in addition multiple lens (54a-c) arrangements 14 according to embodiments of the invention in top view perspectives.

In FIG. 8, the local oscillator port 42 is divided into an input port 42a and an output port 42b. The advantage of this embodiment resides in the increased mechanical stability that the retro of the second cavity end reflector 50 provides. The retro therein combines the different optical paths with respect to the lenses. A further advantage is, that the distance between the ports 42, 44, 46 or additional ports (not shown in the Figures) can be increased, which minimizes crosstalk between the beam paths. In FIG. 9, the second cavity end reflector 50 is a mirror, which is used for both the cavity optical path 15a and the optical path 15b for applying the filter characteristic 80. However, different lenses 54a, 54b are used for these paths 15a, 15b, respectively. In an alternative configuration there is at least one more additional beam path (not shown) that passes through the lens 54b, where through the two ports 24c and 24b (not shown) at least a port of the local oscillator signal 16 is directed and detected, so that a correction signal for the transmission properties of the path 15b can be determined. In FIG. 10, the second cavity end reflector 50 is displayed as a retro. Two of lenses 54a, 54c are arranged to keep the optical path 15b for applying the filter characteristic, while one of the lenses 54b is designed to realize the conventional optical path of the cavity. According to this embodiment, the largest distance between the ports 42, 44, 46 or additional ports (not shown) may be realized and crosstalk is minimized.

The preferred embodiments described in detail above teach particular arrangements of the invention, however, other embodiments are envisioned for this invention including arrangements incorporating gain elements and the use of optical non-reciprocal devices, such as optical isolators and optical circulators that maybe used to suppress reflections, for example from a highly-reflective Fabry-Perot filter cavity frequency selection element, and direct light to achieve the optical filtering function described previously. These alternative embodiments should be apparent to those skilled in the art upon comprehension of the invention taught here-in.

1. An apparatus for determining an optical property of a device under test -DUT-, comprising:
an external cavity providing a first optical path passing a tunable filter arrangement, the tunable filter arrangement being adapted to select a wavelength of a cavity light beam resonating in the external cavity, the external cavity comprising:
a first port for providing at least a fraction of the resonating cavity light beam as an optical stimulus signal to the DUT,
a second port for receiving an optical response signal from the DUT or an optical response signal derived from said optical response signal,
a third port for outputting a filtered response signal,
wherein the second port and the third port are optically coupled by a second optical path passing the tunable filter arrangement spatially different from the first optical path, and
a detector unit optically coupled to the third port for receiving the filtered response signal.

2. The apparatus of claim 1, further comprising a data processing unit connected to the detector unit for deriving the optical property of the device under test from an optical power measured by the detector unit.

3. The apparatus of claim 1, further comprising an optical coupler for generating the optical response signal derived from said optical response signal by superimposing the optical response signal from the DUT with the optical stimulus signal from the external cavity.

4. The apparatus of claim 1, comprising two cavity end reflectors and a diffraction grating, both cavity end reflectors providing the formation of resonance modes with respect to said cavity light beam, said grating being arranged within an optical axis between both cavity end reflectors and adapted for tuning the wavelength of said cavity light beam.

5. The apparatus of claim 1, wherein the second port and the third port are spatially offset from the first port and the optical axis of the cavity.

6. The apparatus of claim 1, further comprising at least a fourth and a fifth port to allow inputting, outputting and filtering of more than one response signal derived from the a device under test.

7. The apparatus of claim 4, wherein the stimulus and response optical signals, or the first and second optical signals coincide on said grating but with different angles of incidence.

8. The apparatus of claim 4, further comprising a lens for simultaneously focusing the optical signals input into a focal plane the arrangement onto said first, second and/or third port or any additional port.

9. The apparatus of claim 8, further comprising at least one beam splitter or mirror which is inserted into the optical path between the lens and the grating or between the lens and the at least one output port, and, to increase the spatial offset between the first port and each of the second and third port.

10. The apparatus of claim 4, wherein the external cavity further comprises at least two lenses and a retro reflector as the second one of the cavity end reflectors, said retro reflector and said two lenses being arranged such that each one of the two lenses focuses the optical response signal, or said second optical signal, onto one of the second or the third port.

11. The apparatus of claim 1, wherein the external cavity further comprises one or more additional ports spatially offset from said first port and the first optical path, for repeatedly inputting at least a portion of the stimulus, or first optical signal, which is previously output from the first port, as a third optical signal into the external cavity for deriving optical properties, particularly insertion loss, when the third signal is output from the one or more additional ports and forwarded to a further detector unit.

12. A method of deriving an optical property of a device under test, comprising:
generating a cavity light beam along a first optical path in external cavity,
selecting a wavelength of the cavity light beam of light by means of a filter arrangement within the external cavity,
providing an optical stimulus signal to a device under test by splitting at least a fraction of the cavity light beam,
providing an optical response signal from the DUT or a signal derived there form back to the external cavity, so that said signal is passed over a second optical path passing the filter arrangement spatially different to the first optical path in order to generate a filtered optical response signal, and
providing said filtered optical response signal to a detector unit.
